(19) United States
(12) Patent Application Publication
(10) Pub. No.: US 2012/0175189 A1
(43) Pub. Date: Jul. 12, 2012

(54) LADDER SAFELY SHOE SYSTEMS

(76) Inventor: Norman Stewart, Greenville, MS (US)

(21) Appl. No.: 13/342,491

(22) Filed: Jan. 3, 2012

Related U.S. Application Data
(60) Provisional application No. 61/430,561, filed on Jan. 7, 2011.

(51) Int. Cl. E06C 7/42; E06C 7/46

(52) U.S. Cl. 182/111

(57) ABSTRACT

Step Ladder Safely Shoe provides security and stability for the base of a ladder and can prevent users from potentially falling off of an unstable ladder. This device acts as shoes (surface-area increasers) for the feet of a step ladder by providing four supportive units into which the ladder's feet can be placed. By using this product, individuals may be able to use a ladder without needing a second person to hold and stabilize the ladder, as well as allowing individuals to easily use the ladder with minimal effort on wet or soft ground.

### CROSS-REFERENCE TO RELATED APPLICATION

The present application is related to and claims priority from prior provisional application Ser. No. 61/430,561, filed Jan. 7, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of ladder accessories and more specifically relates to ladder safely shoe systems.

### 2. DESCRIPTION OF THE RELATED ART

Ladders are typically a set of vertical or inclined rungs or steps. Ladders may be fixed or non-fixed. Fixed ladders are not portable, but provide suitable stability. Non-fixed versions such as folding (step), extension and others are convenient due to their portable nature; however these ladders may be dangerous in-use. Many individuals use ladders either at their job or home. While using a portable ladder may be convenient for ascending and descending from heights, individuals can potentially fall off and injure themselves by using an unstable ladder. Oftentimes, ladders become unstable if they are used on soft or wet ground. This is highly unsafe and inconvenient, as individuals do not always have the time to wait for the proper dry ground conditions. Additionally, ladders can slip or shift if there isn't someone stabilizing the ladder at the bottom. This condition may make it difficult to accomplish anything if an individual is alone, without someone to hold the base of ladder steady.

For safety, a rigid (non-fixed) ladder should ideally be leaned at an angle of about fifteen degrees to the vertical. In other words, the distance from the foot of the ladder to the wall should be about one quarter of the height of the top of the ladder. At steeper angles, the ladder is at risk of toppling backwards when the climber leans away from it. At shallower angles, the ladder may lose its grip on the ground. Ideal conditions often do not exist, as ground surfaces may be uneven or slippery. It is desirable that a ladder accessory provide safety in a reliable manner.

Various attempts have been made to solve the above-mentioned problems such as those found in U.S. Pat. And Pub. Nos. 2,691,479; 2007/0284190; 6,092,625; 2009/0200110; 2008/0029341; and 4,669,576. This art is representative of ladder accessories. None of the above inventions and patents, taken either singly or in combination, is seen to describe the invention as claimed.

Ideally, a ladder safely shoe system should be user-friendly, easy to install and safe in-use, yet would operate reliably and be manufactured at a modest expense. Thus, a need exists for a reliable ladder safely shoe system to effectively prevent ladder slippage and to avoid the above-mentioned problems.

### BRIEF SUMMARY OF THE INVENTION

In view of the foregoing disadvantages inherent in the known ladder accessory art, the present invention provides a novel ladder safely shoe system. The general purpose of the present invention, which will be described subsequently in greater detail is to provide safety for users of ladders despite the relative environmental conditions.

Step Ladder Safely Shoe of the present invention provides security and stability for the base of a ladder (portable or non-portable) and can prevent users from potentially falling off of a wobbly and unstable ladder. This innovative product acts as shoes (surface-area increasers) for the feet of a step ladder by providing four supportive units into which the ladder's feet can be placed. By using this product, individuals may be able to use a ladder without needing a second person to hold and stabilize the ladder, as well as allowing individuals to easily use the ladder with minimal effort on wet or soft ground. Homeowners, landscapers, or individuals using a ladder can benefit from the support and practicality that this product affords.

A ladder safely shoe system as disclosed herein in a preferred embodiment comprising: a ladder (safety) shoe including, a leg receiver; a connector-pivot; exactly two threaded fastener receivers (more or less in alternate embodiments); fasteners; and a baseplate. Leg receiver of ladder shoe receives a leg of a ladder. The leg receiver is connected to the baseplate via the connector-pivot. The leg receiver comprises a rectangular tubular profile opening suitable to receive the leg of the ladder and the leg receiver comprises a toe and a heal contoured to match a butt of the leg of the ladder; wherein the leg receiver may comprise a Parallelepiped.

The toe and the heal of the leg receiver are able to be pivoted in relation to the ground surface via a centerline axis of the connector-pivot such that the ladder is safely located. The threaded fastener receiver receives the fasteners such that the leg of the ladder is able to be removably coupled within the ladder shoe. The connector-pivot may further comprise a bolt, the connector-pivot acting in a capacity of a fulcrum. The baseplate preferably comprises a circular surface-area-increaser; wherein the baseplate comprises a grip-surface located on a bottom of the baseplate. The connector-pivot is able to pivotably adjust the leg of the ladder to a normalized position so as to render the ladder stabilized relative to a ground surface for use by at least one ladder-user.

A kit is also described herein preferably including: four of the ladder safely shoes (one for each ladder leg); fasteners; and a set of ladder-user instructions.

A preferred method of using a ladder safely shoe is disclosed herein preferably comprising the steps of: removably attaching ladder (safely) shoes about a butt of a leg of a portable ladder; threadably-inserting fasteners into threaded fastener receivers such that the leg of the portable ladder is receivedly-affixed within a leg receiver of the ladder safety shoe; and normalizing a relative position via pivotably adjusting a connector-pivot so as to render the portable ladder stabilized relative to a ground surface for use by at least one ladder-user. The method may further comprise the step of removing at least one of the ladder safely shoes for use or for storage.

The present invention holds significant improvements and serves as a ladder safely shoe system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ladder safely shoe systems, constructed and operative according to the teachings of the present invention.

FIG. 1 shows a perspective view illustrating ladder shoes of a ladder safely shoe systems, in an in-use condition on a ladder according to an embodiment of the present invention.

FIG. 2 is a side perspective view illustrating the ladder shoes according to an embodiment of the present invention of FIG. 1.

FIG. 3 is another side perspective view illustrating the ladder shoes according to an embodiment of the present invention of FIGS. 1 and 2.

FIG. 4 is a top perspective view illustrating the ladder shoes according to an embodiment of the present invention of FIGS. 1-3.

FIG. 5 is a flowchart illustrating a method of using the ladder shoes according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a ladder accessory device 110 and more particularly to ladder safely shoe system 100 as used to improve the stability and safety of ladder 130 in use (in-use condition 150.)

Generally speaking, ladder (safely) shoe 112 substantially prevents individuals from falling off of an unstable ladder 130 by providing a means of securing in stasis the base of ladder 130. This unique product may comprise a metal (or non-metal) unit into which the feet 132 of ladder 130 can be placed. The top part of the unit can have a rectangular cup in the shape of foot 132 of ladder 130 and can be attached to a circular disk (baseplate 116.)

There can be screws on either side of the cup that can be adjusted to secure the foot 132 into place. To use, individuals can place the ladder 130 foot 132 into the cup and turn the screws to secure the foot 132.

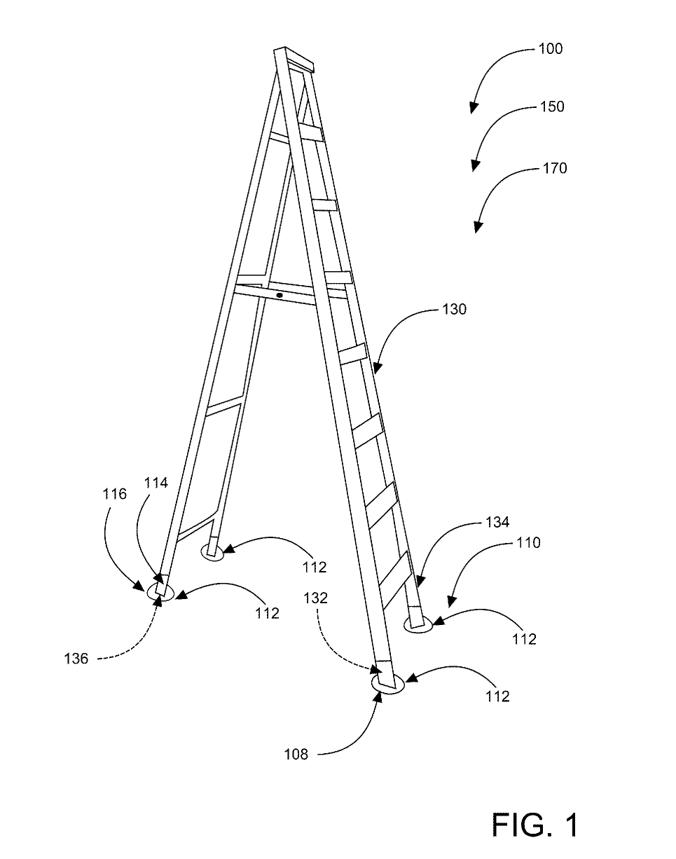

Referring to the drawings by numerals of reference there is shown in FIG. 1, a perspective view illustrating ladder (safely) shoe(s) 112 of a ladder safely shoe systems 100, in an in-use condition 150 on ladder 130 according to an embodiment of the present invention.

Ladder safely shoe system 100 comprises ladder shoe(s) 112; ladder shoe(s) 112 including leg receiver 114; connector-pivot 120; and baseplate 124. Leg receiver 114 of ladder shoe 112 receives leg 134 of ladder 130; wherein leg receiver 114 is connected to baseplate 116 via connector-pivot 120. Connector-pivot 120 is able to pivotably adjust leg 134 of ladder 130 to a normalized position so as to render ladder 130 suitably stabilized relative to a ground surface for use by at least one ladder-user.

Kit 170 may include four of ladder shoe(s) 112; fasteners 118; and a set of instructions. Ladder safely shoe system 100 may be sold as kit 170; ladder safely shoe system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, different shapes, sizes for different ladders 130, customized parts, different fastener means used, parts may be sold separately, etc., may be sufficient.

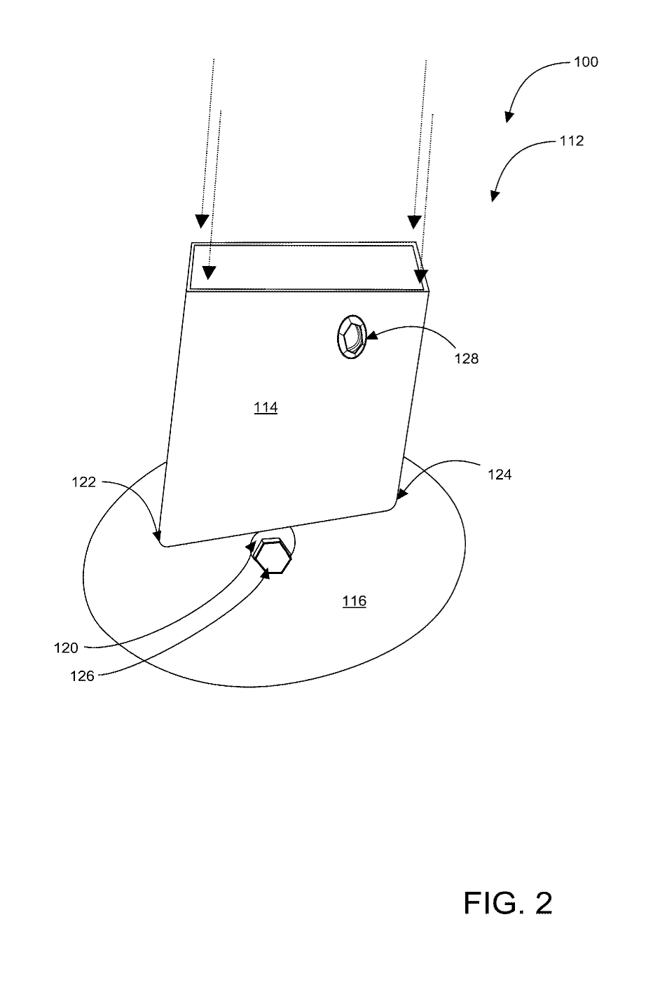

Referring generally now to FIGS. 2-4, starting with FIG. 2 showing a side perspective view illustrating ladder shoes 112 according to an embodiment of the present invention of FIG. 1.

As previously mentioned, ladder safely shoe system 100 comprises leg receiver 114. Leg receiver 114 preferably comprises a rectangular tubular profile opening suitable to receive leg 134 of ladder 130. Leg receiver 114 comprises toe 122 and heal 124 contoured to match butt 136 of leg 134 of ladder 130. Leg receiver 114 comprises a Parallelepiped in preferred embodiments; however other shapes may be used to match legs 134 of ladder 130. Parallelepiped refers to a three-dimensional figure formed by six parallelograms within this disclosure. Leg receiver 114 may also comprise a Rhomboid profile or a non-Rhomboid in alternate embodiments. Toe 122 and heal 124 of leg receiver 114 are able to be pivoted in relation to the ground surface via a centerline axis of connector-pivot 120. Connector-pivot 120 may further comprise bolt 126 or other suitable equivalent fastener/pivoting means. In this way connector-pivot 120 acts in a capacity of a fulcrum.

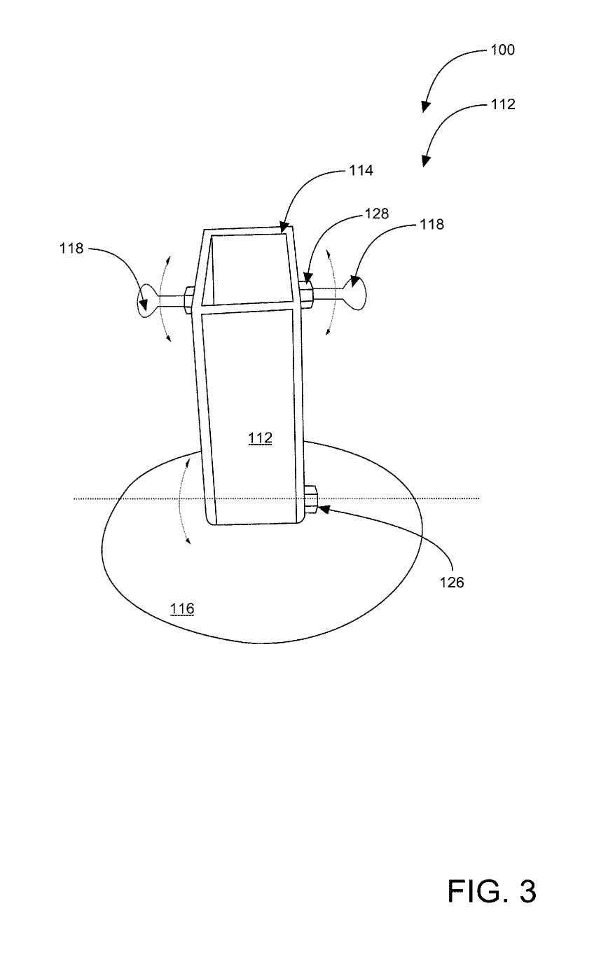

Referring now to FIG. 3, another side perspective view illustrating ladder shoes 112 according to an embodiment of the present invention of FIGS. 1 and 2. Ladder shoes 112 comprise at least one threaded fastener receiver 128 for receiving a fastener 118 such that leg 134 of ladder 130 is able to be removably coupled within ladder shoe 112; preferred embodiments comprising exactly two threaded fastener receivers 128, as shown.

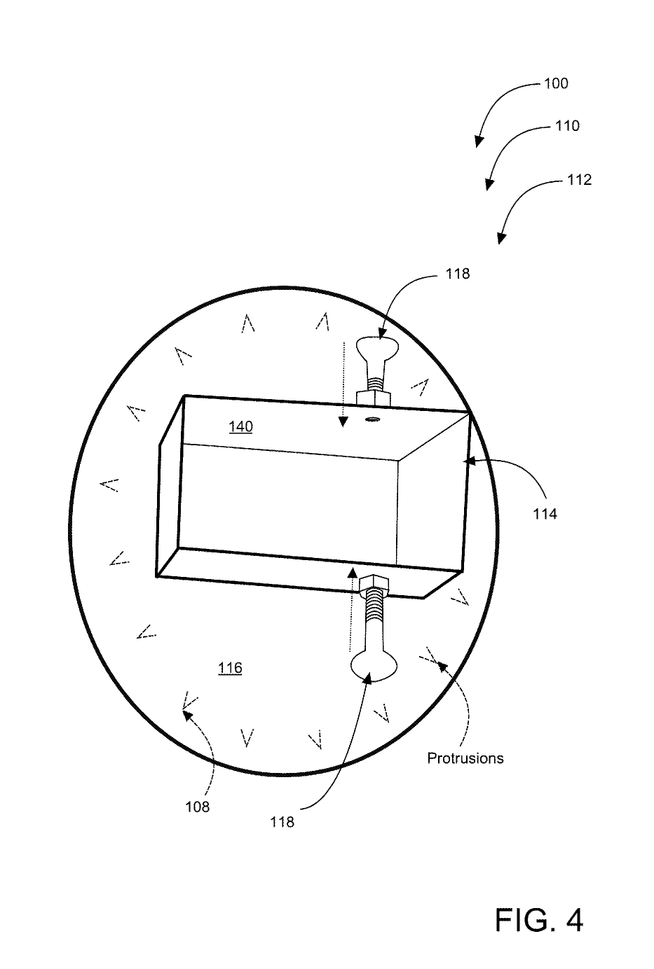

Referring now to FIG. 4, a top perspective view illustrating ladder shoes 112 according to an embodiment of the present invention of FIGS. 1-3.

Baseplate 116 of ladder shoes 112 comprises a surface-area-increaser such that ladder 130 is suitably stabilized on the ground surface, as shown in FIG. 1. The surface-area-increaser comprises a circular cross-section in preferred embodiments however may comprise other shapes such rectangular, square, triangular or the like (non-circular cross-sections for example.) In certain embodiments baseplate 116 comprises grip-surface 108 located on a bottom of baseplate 116 to create an increased friction means with the ground surface (floor, ground or the like.) Grip-surface 108 of baseplate 116 comprises a frictional tread. Grip-surface 108 may comprise rubberized or spray-on material. Grip-surface 108 of baseplate 116 comprises a plurality of pierce protrusions in certain embodiments.

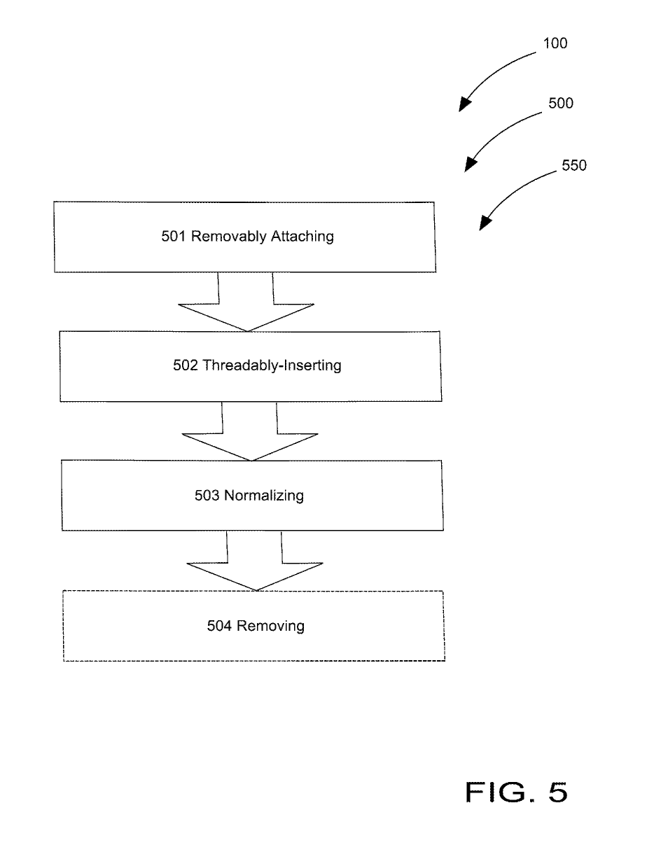

Referring now to FIG. 5, a flowchart 550 illustrating a method of using (method of use 500) ladder shoes 112 according to an embodiment of the present invention of FIGS. 1-4.

Method of use 500 for ladder shoe 112 (ladder safety shoes comprising ladder shoes 112) comprises the steps of: step one 501 removably attaching ladder shoes 112 about butt 136 of leg 134 of (a portable) ladder 130 (step ladder as shown in FIG. 1 or other version); step two 502 threadably-inserting fasteners 118 into threaded fastener receivers 128 such that leg 134 of (portable) ladder 130 is receivedly-affixed within leg receiver 114 of ladder shoe 112 (ladder safety shoe); and step three 503 normalizing a relative position via pivotably adjusting connector-pivot 120 so as to render (portable) ladder 130 stabilized relative to a ground surface for use by at least one ladder-user. Method of use 500 may further comprise step four 504 of removing at least one of ladder shoe 112.

It should be noted that step four 504 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ladder safely shoe system comprising:
a ladder shoe including,
a leg receiver;
a connector-pivot; and
a baseplate;
wherein said leg receiver of said ladder shoe receives a leg of a ladder;
wherein said leg receiver is connected to said baseplate via said connector-pivot; and
wherein said connector-pivot is able to pivotably adjust said leg of said ladder to a normalized position so as to render said ladder stabilized relative to a ground surface for use by at least one ladder-user.

2. The ladder safely shoe system of claim 1 wherein said leg receiver comprises a rectangular tubular profile opening suitable to receive said leg of said ladder.

3. The ladder safely shoe system of claim 2 wherein said leg receiver comprises a toe and a heal contoured to match a butt of said leg of said ladder.

4. The ladder safely shoe system of claim 3 wherein said leg receiver comprises a Parallelepiped.

5. The ladder safely shoe system of claim 3 wherein said leg receiver comprises a Rhomboid.

6. The ladder safely shoe system of claim 3 wherein said leg receiver comprises a non-Rhomboid.

7. The ladder safely shoe system of claim 3 wherein said toe and said heal of said leg receiver are able to be pivoted in relation to said ground surface via a centerline axis of said connector-pivot.

8. The ladder safely shoe system of claim 1 further comprising at least one threaded fastener receiver for receiving a fastener such that said leg of said ladder is able to be removably coupled within said ladder shoe.

9. The ladder safely shoe system of claim 8 further comprising exactly two said threaded fastener receivers.

10. The ladder safely shoe system of claim 1 wherein said connector-pivot further comprises a bolt, said connector-pivot acting in a capacity of a fulcrum.

11. The ladder safely shoe system of claim 1 wherein said baseplate comprises a surface-area-increaser.

12. The ladder safely shoe system of claim 11 wherein said surface-area-increaser comprises a circular cross-section.

13. The ladder safely shoe system of claim 11 wherein said surface-area-increaser comprises a non-circular cross-section.

14. The ladder safely shoe system of claim 1 wherein said baseplate comprises a grip-surface located on a bottom of said baseplate.

15. The ladder safely shoe system of claim 14 wherein said grip-surface of said baseplate comprises a frictional tread.

16. The ladder safely shoe system of claim 14 wherein said grip-surface of said baseplate comprises a plurality of pierce protrusions.

17. A ladder safely shoe system comprising:
a ladder shoe including,
a leg receiver;
a connector-pivot;
exactly two threaded fastener receivers;
fasteners; and
a baseplate;
wherein said leg receiver of said ladder shoe receives a leg of a ladder;
wherein said leg receiver is connected to said baseplate via said connector-pivot;
wherein said leg receiver comprises a rectangular tubular profile opening suitable to receive said leg of said ladder;
wherein said leg receiver comprises a toe and a heal contoured to match a butt of said leg of said ladder;
wherein said leg receiver comprises a Parallelepiped;
wherein said toe and said heal of said leg receiver are able to be pivoted in relation to said ground surface via a centerline axis of said connector-pivot;
wherein said threaded fastener receiver receives said fasteners such that said leg of said ladder is able to be removably coupled within said ladder shoe;
wherein said connector-pivot further comprises a bolt, said connector-pivot acting in a capacity of a fulcrum;
wherein said baseplate comprises a circular surface-area-increaser;
wherein said baseplate comprises a grip-surface located on a bottom of said baseplate; and
wherein said connector-pivot is able to pivotably adjust said leg of said ladder to a normalized position so as to render said ladder stabilized relative to a ground surface for use by at least one ladder-user.

18. The ladder safely shoe system of claim 17 further comprising a kit, said kit including:
four of said ladder shoes;
said fasteners; and
a set of instructions for a ladder-user.

19. A method of using a ladder shoe comprising the steps of:
removably attaching ladder shoes about a butt of a leg of a portable ladder;
threadably-inserting fasteners into threaded fastener receivers such that said leg of said portable ladder is receivedly-affixed within a leg receiver of said ladder shoe; and
normalizing a relative position via pivotably adjusting a connector-pivot so as to render said portable ladder stabilized relative to a ground surface for use by at least one ladder-user.

20. The method of claim 19 further comprising the step of removing at least one of said ladder shoes.
